(19) United States
(12) Patent Application Publication
(10) Pub. No.: US 2026/0204091 A1
(43) Pub. Date: Jul. 16, 2026

(54) SYSTEMS AND METHODS FOR VALIDATING DATA FROM DISPARATE SOURCE INPUTS IN A DISTRIBUTED VALIDATION NETWORK

(71) Applicant: BANK OF AMERICA CORPORATION, Charlotte, NC (US)

(72) Inventors: Suryanarayan Parthasarathi Chakravarthi, Chennai (IN); Sukanya V, Chennai (IN); Harinath C, Hyderabad (IN); Bharat Indrakanti, Hyderabad (IN)

(73) Assignee: BANK OF AMERICA CORPORATION, Charlotte, NC (US)

(21) Appl. No.: 19/021,598

(22) Filed: Jan. 15, 2025

(51) Int. Cl. G06V 30/416; G06V 30/19

(52) U.S. Cl. CPC G06V 30/416; G06V 30/19013

(57) ABSTRACT

Systems, computer program products, and methods are described herein for validating data from disparate source inputs in a distributed validating network. The present disclosure is configured to identify at least one document, wherein the at least one document comprises at least one alphanumeric character; determine a user account identifier based on the at least one document or the at least one alphanumeric character; extract user account data from a user account database based on the user account identifier; apply the user account data to an alphanumeric generation engine; generate, by the alphanumeric generation engine, an alphanumeric prompt; and compare the alphanumeric prompt to the at least one alphanumeric character.

### TECHNOLOGICAL FIELD

Example embodiments of the present disclosure relate to validating data from disparate source inputs in a distributed validation network.

### BACKGROUND

In automated optical character recognition (OCR) systems, many issues arise when these OCR system cannot accurately determine the alphanumeric characters from scanned images of the documents, pictures of the documents, and/or the like. For instance, such issues may arise where the document has errors printed, has stains, and/or the like. Further issues may arise where multiple disparate teams and sources must provide their approvals or validations from different user devices in a distributed network, and these approvals may comprise insecure data transmissions and/or great delays in validating the documents. Thus, a system or method for validating data (such as document data) from disparate source inputs (e.g., disparate user devices) in a distributed validation network is needed to resolve such technical problems.

Applicant has identified a number of deficiencies and problems associated with validating data from disparate source inputs in a distributed validation network. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for validating data from disparate source inputs in a distributed validation network.

In one aspect, a system for validating data from disparate source inputs in a distributed validation network is provided. In some embodiments, the system may comprise: a memory device with computer-readable program code stored thereon; at least one processing device operatively coupled to the memory device and at least one communication device, wherein executing the computer-readable code is configured to cause the at least one processing device to: identify at least one document, wherein the at least one document comprises at least one alphanumeric character; determine a user account identifier based on the at least one document or the at least one alphanumeric character; extract user account data from a user account database based on the user account identifier; apply the user account data to an alphanumeric generation engine; generate, by the alphanumeric generation engine, an alphanumeric prompt; and compare the alphanumeric prompt to the at least one alphanumeric character.

In some embodiments, executing the computer-readable code is configured to cause the at least one processing device to: identify a document-generator user approval associated with the at least one document; identify, based on the comparison of the alphanumeric prompt and the at least one alphanumeric character, a management entity approval or management entity disapproval; and identify at least one of an end-user approval or an end-user disapproval.

In some embodiments, at least one of the management entity disapproval or the end-user disapproval is identified, and wherein executing the computer-readable code is configured to cause the at least one processing device to: identify at least one rejection factor associated with the at least one document; determine at least one team identifier associated with the at least one rejection factor; transmit at least one approval request associated with the at least one rejection factor to at least one user device associated with the at least one team identifier; and receive at least one approval from the at least one user device. In some embodiments, the at least one user device comprises a plurality of user devices associated with a secure peer network applied on a browser window. In some embodiments, the at least one user device comprises a plurality of user devices, and wherein the transmission of the at least one approval request comprises a plurality of approval requests transmitted in parallel.

In some embodiments, executing the computer-readable code is configured to cause the at least one processing device to: capture an image of a user or a user account associated with the user device that transmitted the at least one approval; embed the image into the at least one document in at least one document database; and convert the image into a string of numeric characters. In some embodiments, the at least one document database is a secret database.

In some embodiments, the at least one alphanumeric character comprises a string of numeric characters.

In some embodiments, the alphanumeric generation engine is a self-attentive transformer comprising at least one deep learning model.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for validating data from disparate source inputs in a distributed validation network, in accordance with an embodiment of the disclosure;

FIG. 2 illustrates a process flow for validating data from disparate source inputs in a distributed validation network, in accordance with an embodiment of the disclosure;

FIG. 3 illustrates a process flow for identifying a document-generator user approval, a management entity approval or disapproval, and an end-user approval or disapproval, in accordance with an embodiment of the disclosure;

FIG. 4 illustrates a process flow for receiving an approval of the at least one rejection factor associated with the at least one document from a user device, and an end-user approval or disapproval, in accordance with an embodiment of the disclosure;

FIG. 5 illustrates a process flow for converting a generated image associated with each approval of the rejection factor(s) to a string of numeric characters, in accordance with an embodiment of the disclosure;

FIG. 6 illustrates a flow diagram for generating the alphanumeric prompt and identifying document-generator user approval, management-entity approval or disapproval, and end-user approval or disapproval, in accordance with an embodiment of the disclosure;

FIG. 7 illustrates a flow diagram for updating the rejection factors for the document validation, in accordance with an embodiment of the disclosure; and

FIG. 8 illustrates a flow diagram 800 for using a SPEER network, generating an image of the user associated with each user device, and converting the image to a binary string, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

In automated optical character recognition (OCR) systems, many issues arise when these OCR system cannot accurately determine the alphanumeric characters from scanned images of the documents, pictures of the documents, and/or the like. For instance, such issues may arise where the document has errors printed, has stains, and/or the like. Further issues may arise where multiple disparate teams and sources must provide their approvals or validations from different user devices in a distributed network, and these approvals may comprise insecure data transmissions and/or great delays in validating the documents. Thus, a system or method for validating data (such as document data) from disparate source inputs (e.g., disparate user devices) in a distributed validation network is needed to resolve such technical problems.

Accordingly, the present disclosure provides a system or method that identifies at least one document, wherein the at least one document comprises at least one alphanumeric character; determines a user account identifier based on the at least one document or the at least one alphanumeric character; extracts user account data from a user account database based on the user account identifier; and applies the user account data to an alphanumeric generation engine. Further, the system or method may generate, by the alphanumeric generation engine, an alphanumeric prompt; and compare the alphanumeric prompt to the at least one alphanumeric character. Additionally, and in some embodiments, the system or method may identify a document-generator user approval associated with the at least one document; identify, based on the comparison of the alphanumeric prompt and the at least one alphanumeric character, a management entity approval or management entity disapproval; and identify at least one of an end-user approval or an end-user disapproval. Additionally, the system and/or method may capture an image of a user or a user account associated with the user device that transmitted the at least one approval with respect to the at least one validation from the disparate input sources (e.g., a team member associated with a management-entity); embed the image into the at least one document in at least one document database; and convert the image into a string of numeric characters.

In other words, the disclosure provides a system for validating data from disparate source inputs in a distributed validation network. For example, and in document validation processes where the documents are received from remote disparate sources (e.g., disparate point of sale devices, ATMs, mobile devices, and/or the like), it is increasingly difficult to validate these documents when incorrect keys have been input (such as incorrect key strings for a check number), where character recognition using a camera works incorrectly, where user details are input incorrectly, and/or the like. Thus, the disclosure provides a system comprising a numeric generation prompt engine that uses self-attentive transformers (such as an alphanumeric generation engine) trained on user account data (such as current check numbers that are in possession of the user and have not been used from a user account database) to generate a likely document identifier (e.g., a check number) that will match the received data/document. Further, the disclosure may provide a secure peer network connection and approval system that works in parallel with a validation process to identify distributed network devices to receive all or some of the data for approval. In some embodiments, the system may determine missing information needed to approve the document, and based on this specific missing information, the system may automatically and in near real time transmit the necessary data to an identified user device(s) for approval.

What is more, the present disclosure provides a technical solution to a technical problem. As described herein, the technical problem includes the determination of alphanumeric characters in a document for validation of the document, and validating of the document in a distributed validating network without undue data security threats or delayed responses from user devices. The technical solution presented herein allows for the automatic, efficient, and secure determination of alphanumeric characters in a secure network, and the automatic transmission of approval requests to a plurality of user devices in a distributed validation network. In particular, the disclosure is an improvement over existing solutions to the the above-identified problems in technology, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

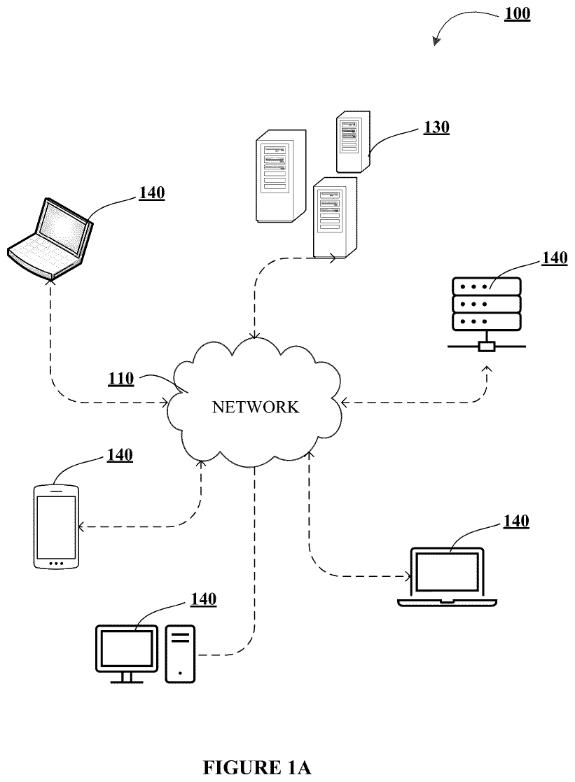

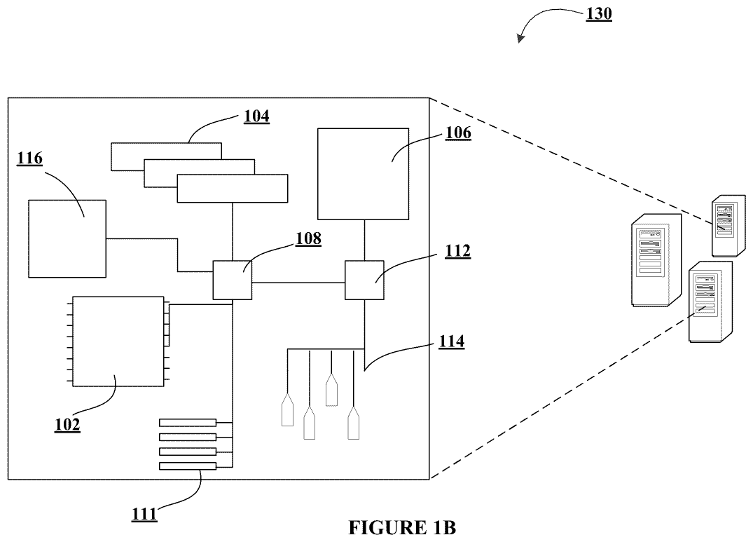

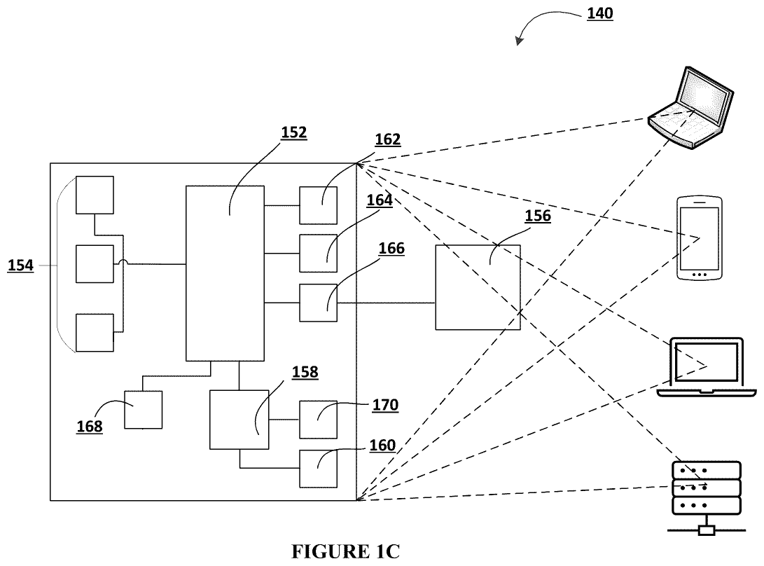

FIGS. 1A-1C illustrate technical components of an exemplary distributed computing environment for validating data from disparate source inputs in a distributed validation network 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

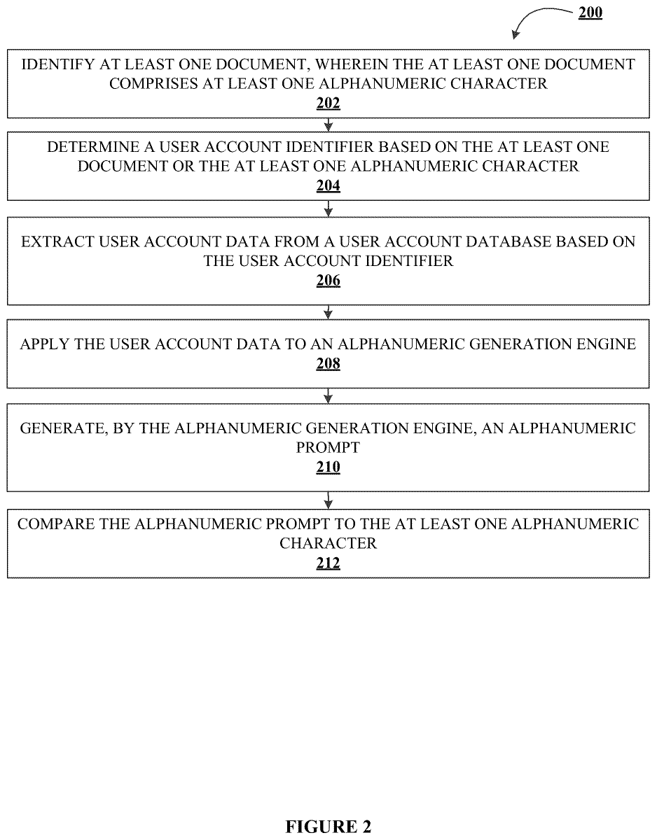

FIG. 2 illustrates a process flow 200 for validating data from disparate source inputs in a distributed validation network, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 may include the step of identifying at least one document, wherein the at least one document comprises at least one alphanumeric character. For instance, the system may identify at least one document based on receiving a photocopy of the document from at least one separate device (such as an ATM, a mobile device, a device at a management entity's brick and mortar location, and/or the like). In some such embodiments, the document (or a photocopy of the document) may be received by the system such as where an owner of the document or a current possessor of the document, and/or the like, submits the document for analysis, for completing a resource transaction, and/or the like. The system may receive a photocopy of the document once the document has been received at a separate device, such as an ATM device in an instance where the document is a check, a mobile device where an image of the check is captured at a user's mobile device that comprises a financial institution application, and/or the like. In some embodiments, the system may receive a photocopy of the document from a separate device such as a device associated with a brick and mortar location of a financial institution. Additionally, and/or alternatively, the system may receive a photocopy or a scanned image of the document from a user device associated with a network the system operates in (e.g., a network associated with a management entity that generated or operates a user account associated with the document).

Additionally, and as used herein, the at least one document may refer to a check, a document to be processed that comprises any alphanumeric characters used to verify or validate the document (such as a physical copy of a document, an original copy of the document, a virtual copy of the document, and/or the like), and/or the like. Thus, and in some embodiments, the at least one document may comprise a check, which may be validated at least in part based on the check number associated with each individual check and used to identify each individual check in a series of checks issued to the user. Thus, and as used herein, each document may comprise at least one alphanumeric character which may be analyzed by the system described herein to validate the document. In some such embodiments, the alphanumeric character(s) may refer to a check number which may identify the specific check being analyzed and validated by the system. Thus, and in some such embodiments, the at least one alphanumeric character may comprise a string of numeric characters. However, and in some embodiments, the at least one alphanumeric character may comprise a string of alphanumeric characters such as but not limited to letters, numbers, symbols, and/or the like.

As shown in block 204, the process flow 200 may include the step of determining a user account identifier based on the at least one document or the at least one alphanumeric character. For example, the user account identifier referred to herein may be associated with a user's checking account, a username associated with a user account, a user account resource account, and/or the like. In some embodiments, the user account identifier may be used to determine checking account details, identify user account details from a user account database comprising past checks (and their sequence of check numbers used), identify data that needs to remain secure from hacking or misappropriation in the user a user account identifier associated with a user's account, and/or the like.

In some embodiments, the identification of the user account identifier may be based on the at least one document which may comprise the user account identifier details on the face of the document (e.g., a letterhead on the document may comprise the user account identifier, a name of the user, an email address of the user, and/or the like), or may comprise the user account identifier details in a scannable indicia on the document (e.g., a barcode or QR code may be scanned to show the user account identifier), a resource account identifier associated with the user account (e.g., a routing number, an account number, and/or the like), and/or the like. In other words, the identification of the user account identifier may be based on the at least one alphanumeric character which may comprise the user account identifier within a string of alphanumeric characters (e.g., a checking account identifier may be shown with the routing number on the face of the document), and/or the like.

As shown in block 206, the process flow 200 may include the step of extracting user account data from a user account database based on the user account identifier. For example, the user account data may comprise the sequence of serial numbers already used by the user account, such as the previous checks already used by the user of the user account, or any other such documents that have been used by the user that cannot have copies and are identified based on their data within the document and/or alphanumeric characters in the document. Thus, and in some such embodiments, the system may extract this user account data from a user account database based on querying the user account identifier within the user account database and extracting the user account data stored with the user account identifier. In this manner, the system may extract the data associated with past or historical documents used by the user account (such as historical checks used by the user that cannot be re-used, and each of these checks may be identified based on their check numbers), and use this extracted user account data to validate the current document being analyzed by the system (e.g., validate the check number of the document). Additionally, and as understood by a person of skill in the art, the examples provided herein regarding the validation of checks based on their check numbers may be understood as exemplary uses and are not intended to limit the scope of the system described herein. Instead, and as understood by a person of skill in the art, the system described herein may be used for validation of any document comprising a document identifier with alphanumeric characters used for tracking the document.

Thus, and as used herein, the user account database may comprise a dataset of historical data for each user account associated with the system, associated with a management entity of the system (e.g., a financial institution), and/or associated with a plurality of managing entities (e.g., a plurality of financial institutions in a peer to peer to network). Therefore, and in some such embodiments, the user account database may organize its data based on each user account identifier, and such organization may allow for efficient querying and recall of the user account data for each user account identifier.

As shown in block 208, the process flow 200 may include the step of applying the user account data to an alphanumeric generator engine. For example, the system may apply the user account data that was extracted to an alphanumeric generator engine which may comprise deep learning models. In some embodiments, this alphanumeric generator engine may be a self-attentive transformer which is configured to generate a series of numbers (e.g., check numbers, form numbers, document identifiers, and/or the like), based on the last issued documents with assigned alphanumeric characters (e.g., last issued checks and the pending checks not yet used by the user). In this manner, the alphanumeric generator engine does not generate these series of alphanumeric characters in random, but instead makes a determination of the likely alphanumeric character(s) used in the document at issue and being analyzed by the system.

Thus, such an alphanumeric generator engine may allow for validation of the document in a dynamic and learned way, such that even as the format of the alphanumeric character strings may be updated, the alphanumeric generator engine may continuously learn these new formats and implement the new formats in real time or near real time as the documents are received and analyzed by the system.

In some embodiments, the alphanumeric generator engine may generate a plurality of alphanumeric prompts that an operator of the system and/or an operator within a managing entity of the system may select from the alphanumeric prompts the most likely match to the alphanumeric characters shown in the document.

Importantly, and in previous systems, third party operators may have been used to manually validate these documents when OCR failed. Thus, by allowing these third party operators to access the document data (including the alphanumeric characters used to validate the document), this allows for exposure to information these operators should not know about user accounts and their user account details. Therefore, and in contrast to these prior systems, using this alphanumeric generator engine, these operators (in an instance where these operators may still need to validate these documents) will at least have a few prompts of the check numbers that can be keyed-in without necessarily having access to a database of user account details, and thus, the use of this alphanumeric generator engine allows for improved data security and less network transmissions and database querying by these operators. Further, this alphanumeric generator engine may allow management-entities to create their own generation methods, and this way, any external entities trying to clone the management-entity's alphanumeric character sequences used for validation (e.g., checks numbers) will not be aware of the internal alphanumeric generator engine's method, style, or pattern of generating these prompts, especially when the documents are not readily available for copying or analyzing by these external entities.

In some such embodiments, the alphanumeric generator engine may be designed and configured to analyze the data from the user account data associated with the specific user account identifier. Additionally, and based on this data, the alphanumeric generator engine may generate at least one alphanumeric prompt that may match or closely match to the alphanumeric character(s) used to validate the document.

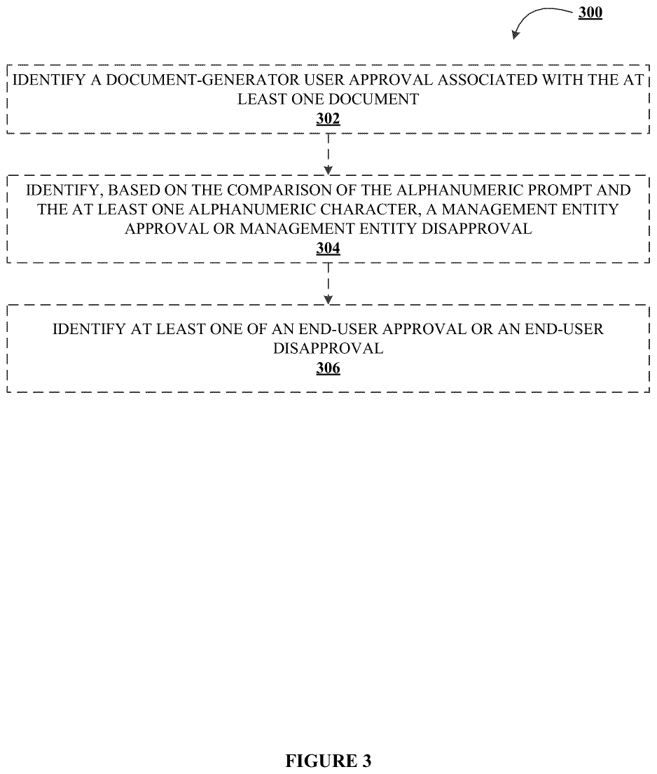

As shown in block 210, the process flow 200 may include the step of generating, by the alphanumeric generator engine, an alphanumeric prompt. For example, and as described briefly above, the system may use the alphanumeric generator engine to generate at least one (or a plurality of) alphanumeric prompt which may match or closely resemble the alphanumeric character(s) identified in block 202. In this manner, the system may generate an alphanumeric prompt that may be compared to the alphanumeric character(s) to validate the document and send the document for further processing (e.g., such as further processing described in FIGS. 3-5).

In some such embodiments, the alphanumeric generator engine may generate this alphanumeric prompt(s) based on the already used documents and their alphanumeric characters that were used for validation. Each of the alphanumeric characters that were validated with the historically used documents may be understood by the system as only allowed to use one time (e.g., a check number may only be used one time for checks associated with a user account). Thus, and based on these historical alphanumeric characters, the alphanumeric generator engine may determine one or more likely alphanumeric prompts that match the alphanumeric characters being analyzed, and thus, in an instance where at least one alphanumeric prompt does match the alphanumeric character(s), then the document may be validated and sent for further processing.

As shown in block 212, the process flow 200 may include the step of comparing the alphanumeric prompt to the at least one alphanumeric character. Thus, and as described briefly above, the system may compare the alphanumeric prompt(s) to the at least one alphanumeric character(s), to validate the document.

In some embodiments, the comparison may occur by a manual review by an operator associated with the system. By way of non-limiting example, the alphanumeric prompt may be transmitted to a user device associated with a user that can confirm or deny the alphanumeric character(s) on the document based on the alphanumeric prompt. For instance, the alphanumeric prompt may comprise a plurality of potential alphanumeric strings that may match the at least one alphanumeric character. For instance, and where the alphanumeric characters on the front of the document are associated with a check number of XYZ-1088, then the alphanumeric prompt may comprise a plurality of potential alphanumeric strings starting after the latest check number used by the user (which may have been XYZ-1077), so the alphanumeric prompt may comprise XYZ-1078, XYZ-1079, XYZ-1080, XYZ-1081, XYZ-1082, XYZ-1083, XYZ-1084, XYZ-1085, XYZ-1086, XYZ-1087, XYZ-1088, XYZ-1089, and so on for each of the check numbers that have not yet been used by the user but have been given to the user.

In some embodiments, the system may automatically generate the alphanumeric prompt to comprise the sequence of numbers that is the closest match to the alphanumeric character(s). For instance, if the closest matches to the check number of XYZ-1088 are XYZ-1066 or XYZ-1088, and the alphanumeric generator engine has determined that XYZ-1066 has already been used, then the alphanumeric generator engine may only generate the alphanumeric prompt to comprise XYZ-1088.

FIG. 3 illustrates a process flow 300 for identifying a document-generator user approval, a management entity approval or disapproval, and an end-user approval or disapproval, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

In some embodiments, and as shown in block 302, the process flow 300 may include the step of identifying a document-generator user approval associated with the at least one document. For example, and in some such embodiments, the system may automatically determine a document-generator user (e.g., the user that is associated with the user account that submitted the document for validation and use, such as the user that submitted the check for processing) has approved the document. Thus, and in some such embodiments, the identification of the document-generator user approval may be based on the validation of the alphanumeric character(s) described in FIG. 2, and upon validating the document, the document-generator user approval may be automatically recorded. For example, and by validating the check associated with the check number that was compared to the alphanumeric prompt, the system may automatically and in real time or near real time determine the document-generator user has approved the document (i.e., the user that is associated with the user account and that submitted the check for a resource transaction has approved the check).

In some embodiments, and as shown in block 304, the process flow 300 may include the step of identifying, based on the comparison of the alphanumeric prompt and the at least one alphanumeric character, a management entity approval or management entity disapproval. For instance, and in some such embodiments, the system may automatically identify a management-entity approval based on the validation of the document. Thus, and in some embodiments, the validation of the document described above with respect to FIG. 2 may be used by the system to automatically determine the management entity approval (where the document is validated—the check number is validated) or the management entity disapproval (e.g., the document is not validated—the check number cannot be validated).

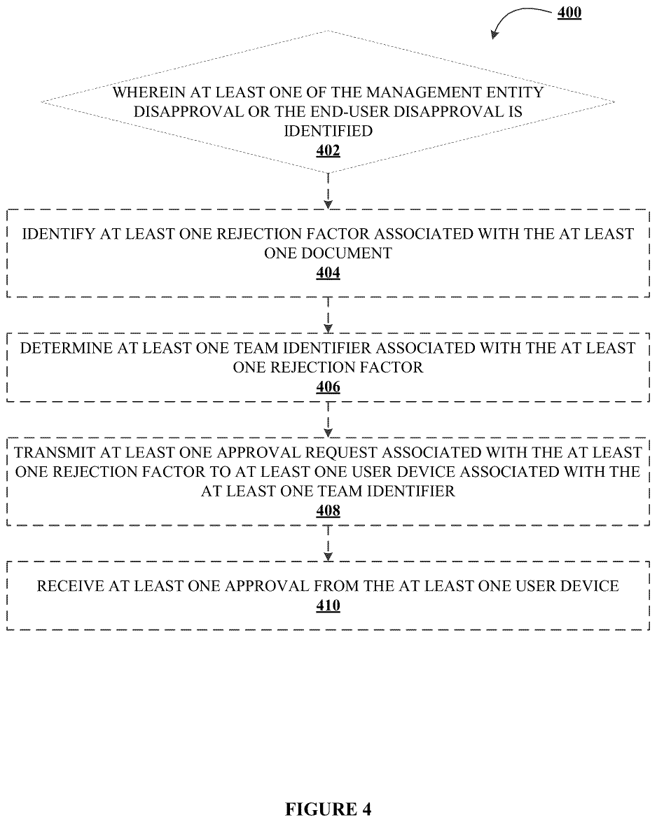

Additionally, and/or alternatively, the validation of the document may further comprise a series of validation steps by a plurality of teams within the management entity. For example, and in some such embodiments, the validation of the document (and thus, the approval by the management-entity) may further comprise a confirmation of user account details, such as but not limited to the user account identifier, the user account number, the approval information of a resource transaction, an approval status of the resource transaction, a recipient identifier and information, a resource amount and agreement, and/or the like. In some such embodiments, the management-entity may require some or all of these user account details to be confirmed in order for the document to comprise a management-entity approval. Thus, and where any of these user account details cannot be confirmed automatically, then the system may determine a management-entity disapproval has occurred and the system may send the document to at least one team within the management-entity to resolve the user account detail issues. In some embodiments, and as described in later detail herein, the need for resolving these user account details may be referred to as a rejection factor and such an embodiment is described in further detail below with respect to FIG. 4.

In some embodiments, and as shown in block 306, the process flow 300 may include the step of identifying at least one of an end-user approval or an end-user disapproval. For instance, the system may identify a recipient user of the document (such as a recipient user of the resource transaction associated with the check), and identify whether the end-user has approved or disapproved the document (and/or the underlying resource transaction). In some embodiments, the disapproval by the end-user may occur without the intent of the end-user. For example, an end-user may accidently wait too long to cash a check they received from the document-generator user, and thus the check may be voided by the time the end-user submits the check for processing of the resource transaction, and in such an instance, the system may record this voiding of the check as an end-user disapproval. In some embodiments, the end-user disapproval may be based on the end-user rejecting the resource transaction associated with the document, by the misspelling and/or misidentification of the end-user on the document, and/or the like.

In contrast, and in some embodiments where the end-user submits the document for processing on time, the end-user is properly identified, the resource amount is correct, and/or the like, then the system may identify the end-user's approval of the document.

FIG. 4 illustrates a process flow 400 for receiving an approval of the at least one rejection factor associated with the at least one document from a user device, and an end-user approval or disapproval, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, the process flow 400 may start with block 402, which comprises a determination that at least one of the management entity disapproval and/or the end-user disapproval is identified. Thus, and in some embodiments, the process described herein with respect to FIG. 4 may follow the process described above with respect to FIG. 3. Thus, and in some such embodiments, the system may first identify at least one disapproval from the management-entity and/or the end-user before continuing with the process of FIG. 4.

In some embodiments, and as shown in block 404, the process flow 400 may include the step of identifying at least one rejection factor associated with the at least one document. For example, and in some such embodiments, the system may identify at least one rejection factor based on the disapproval received from the management-entity and/or the end-user. Thus, and in some such embodiments, the rejection factor may comprise an identification of a reason for why the document cannot be processed and, in the instance where the document is a check, the resource transaction cannot be completed. Therefore, and in some embodiments, the rejection factor may comprise a rejection of an account identifier, an account number for the document (e.g., an account number associated with the check), an approval of the document or information within the document, an approval status, a receiver information (end-user information), a resource amount and agreement, and/or the like. Additionally, and in some embodiments, the management-entity may comprise a plurality of teams or operator groups that are capable and allowed to resolve one of the rejection factors. Such an embodiment is described in further detail below.

In some embodiments, and as shown in block 406, the process flow 400 may include the step of determining at least one team identifier associated with the at least one rejection factor. For example, the system may determine at least one team identifier associated with each rejection factor. In some embodiments, the team identifiers determined by a system may based on a team database associated with and/or operated by the management-entity, which the system may access and gather identifiers for each team of users that can resolve each rejection factor. Thus, and based on identifying each team and/or each user within each team, the system may automatically transmit an approval request to at least one user device associated with each team (e.g., a user device associated with a user within each team, and/or a plurality of user devices associated with a plurality of users within each team. Such an approval request may comprise data of the document and/or the underlying resource transaction associated with the document (e.g., the data necessary) to resolve the rejection factor such that the user of the user device can resolve the rejection factor without showing secure data that isn't necessary for the team to resolve the team's specific rejection factor.

In some embodiments, and as shown in block 408, the process flow 400 may include the step of transmitting at least one approval request associated with the at least one rejection factor to at least one user device associated with the at least one team identifier. For instance, and in some such embodiments, the system may transmit the at least one approval request to the identified user device associated with the team identifier that will resolve the rejection factor. Additionally, and in some embodiments where the at least one approval request comprises a plurality of approval requests, the system may automatically and in real time or near real time transmit a plurality of approval requests to a plurality of user devices associated with the plurality of teams identified as being able to resolve a plurality of rejection factors in parallel. In some embodiments, the at least one approval request transmitted to the at least one user device may further comprise data of the document, of the user account, of the end-user, and/or the like, that is necessary to resolve the specific rejection factor.

In some embodiments, the transmission of the at least one approval request may comprise an access by the user device to a secure peer to peer network between each of the teams associated with each approval request, such that the data accessed by each team may remain secured and within a private network over a browser session in a secure and private manner. In other words, and in some embodiments, the at least one user device comprises a plurality of user devices associated with a secure peer network applied on a browser window. In this manner, the secure peer network (or SPEER) may allow team users to view, approve, set conditional approvals, and/or update the approvals/rejection factors in one session hosted by a management-entity in a single browser. In some embodiments, the secure peer network may comprise a virtual private network (VPN) to secure only one browser session and to receive inputs and/or acknowledgements securely and privately, while also allowing for a database to track each of the acknowledgements, approvals, and/or the like form each team.

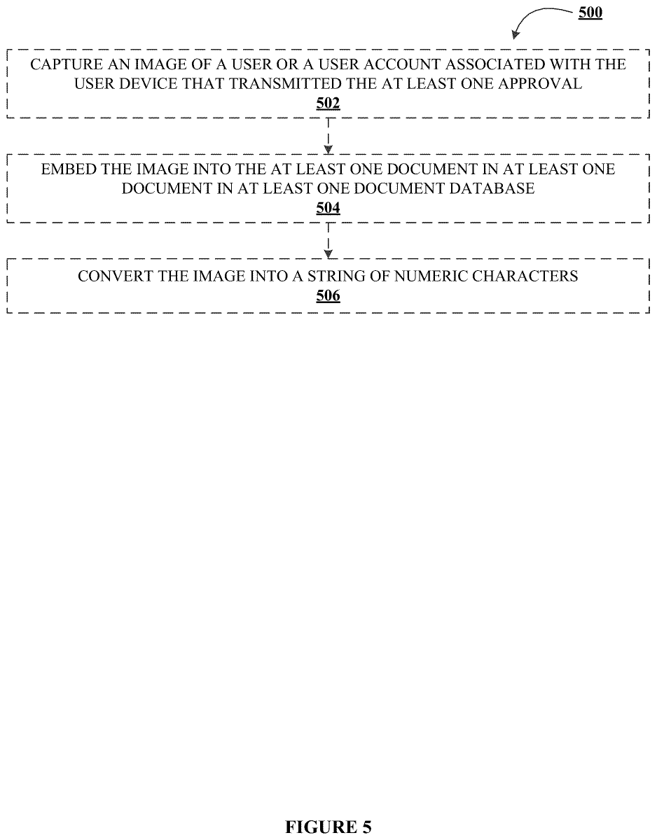

In some embodiments, and as shown in bock 410, the process flow 400 may include the step of receiving at least one approval from the at least one user device. For example, the system may receive an approval from each user device that received the approval request. In some embodiments, the system may capture the approval and/or any user inputs from the user devise with an image of the user that approved or input the user input on the document for later access and confirmation of the original team user that approved each rejection factor. In some such embodiments, the image of the user may additionally be converted to a string of binary characters and such a binary string may be stored in a secret database for later access. Such an embodiment is described in more detail below with respect to FIG. 5.

Additionally, and upon receiving all the approvals associated with all the rejection factors, the system may record the management-entity and/or the end-user approval and send the document to complete processing (e.g., complete the resource transaction). In some embodiments, and where a final team is needed to approve the document after each of the teams associated with the rejection factors, then the system may automatically transmit the document for processing (e.g., over the SPEER network) to the final team. In some such embodiment, such a final team may receive an approval request to review each of the approvals received for each rejection factor and confirm that each approval is correct from each previous team.

FIG. 5 illustrates a process flow 500 for converting a generated image associated with each approval of the rejection factor(s) to a string of numeric characters, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500.

In some embodiments, and as shown in block 502, the process flow 500 may include the step of capturing an image of a user or a user account associated with the user device that transmitted the at least one approval. For example, and in some such embodiments, the system may capture an image of the user associated with the user device (e.g., the user associated with the team identifier that is tasked with resolving the rejection factor) in real time or near real time to the user inputting their user input (e.g., the approval of the rejection factor, the user input associated with the rejection factor, and/or the like). In some embodiments, the image may be captured by the user device itself (such as by a user device's camera, and/or by a camera operatively coupled with the user device). In some embodiments, the image may comprise an image of the user account identifier and user input associated with the user that submits their approval and/or user input at the user device, instead of a picture of the user.

In some embodiments, and as shown in block 504, the process flow 500 may include the step of embedding the image into the at least one document in at least one document in at least one document database. For example, and in some such embodiments, the system may embed the image into the document that is being processed by the system, and this embedding of the image may be used for quick and secured extraction of the user identifier(s) that each approved the document and any other data needed for later inspection.

In some embodiments, the embedding of the image in the document further comprises a storage of the document (and the image) in a secret database. Such a secret database may comprise a database such as a MongoDB® database. Thus, and by using this secret database, the system may store each of the documents within its own secured database that is separate and secure from the user account database, and thus may remain secure from any outside operators or any operators which are not required to view these documents and their approval data.

In some embodiments, and as shown in block 506, the process flow 500 may include the step of converting the image into a string of numeric characters. Additionally, and in some such embodiments, the system may convert the image embedded in the document to a string of alphanumeric characters (such as binary characters), which may later be used for a secure recall of the image from the secret database. Additionally, or alternatively, the conversion of the image to numeric characters may additionally allow for updating to a distributed ledger one time with each of the numeric character strings used for each of the approvals. In some such embodiments, each of the numeric character strings may be stored on a same block within the distributed ledger, and in an instance where the approvals, user inputs, timestamps, and/or the like are updated, then the current block of the distributed ledger may add a timestamp with the numeric character string. Thus, and in some such embodiments, the updating of the underlying data regarding the document and the approvals may not require a new block to be added to the distributed ledger.

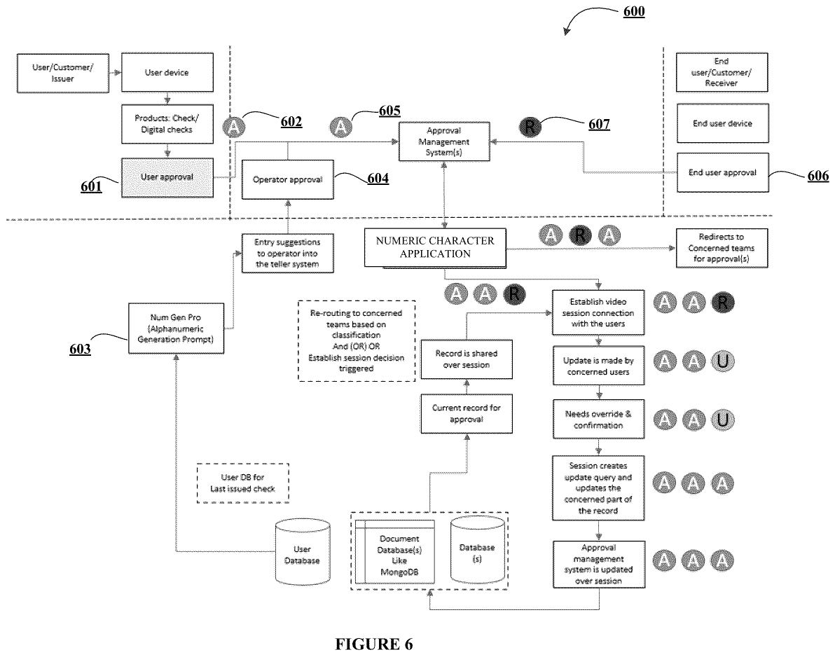

FIG. 6 illustrates a flow diagram 600 for generating the alphanumeric prompt and identifying document-generator user approval, management-entity approval or disapproval, and end-user approval or disapproval, in accordance with an embodiment of the disclosure. In some embodiments, a system (e.g., similar to one or more of the systems described herein with respect to FIGS. 1A-1C) may perform one or more of the steps of flow diagram 600. For example, a system (e.g., the system 130 described herein with respect to FIG. 1A-1C) may perform the steps of flow diagram 600.

As shown in flow diagram 600, the system shows a process for generating the alphanumeric prompt using the alphanumeric generation prompt engine 603 to generate the alphanumeric prompt based on the user account identifier and the user database (user account database). Additionally, and as shown in flow diagram 600, the document-generator user approval is shown as “A” 602, the management-entity approval is shown as “A” 605 from the operator approval 604, and the end-user disapproval is shown as “R” 607 from the end-user approval determination 606. Additionally, and as shown in flow diagram 600, the indicators of “A” may indicate an approval (from the document-generator user, the management-entity, or the end-user), the “R” may indicate a rejection (from the document-generator user, the management-entity, or the end-user), and the “U” may indicate an update or validation process currently occurring to update the previous rejection factor/rejection indicator. Thus, and as shown in flow diagram 600, the system may update each of the rejections (which may have been based on one or more rejection factors) until all approvals have been received.

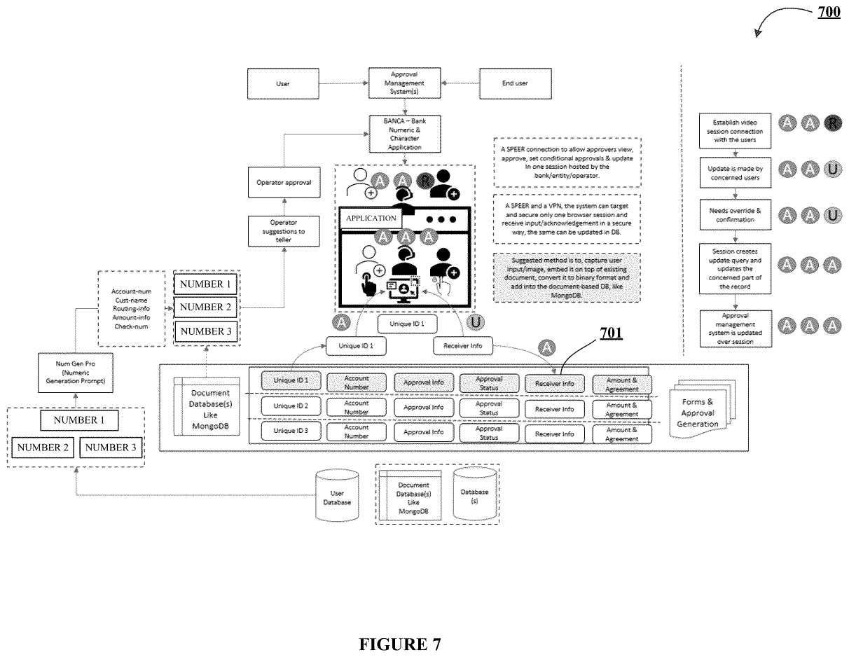

FIG. 7 illustrates a flow diagram 700 for updating the rejection factors for the document validation, in accordance with an embodiment of the disclosure. In some embodiments, a system (e.g., similar to one or more of the systems described herein with respect to FIGS. 1A-1C) may perform one or more of the steps of flow diagram 700. For example, a system (e.g., the system 130 described herein with respect to FIG. 1A-1C) may perform the steps of flow diagram 700.

As shown in flow diagram 700, the system may update the rejection factors associated a document by receiving and/or identifying an approval from a user device associated with a team identifier. For example, and as shown at receiver info block 701, the system may identify that the receiver info 701 is the only rejection factor for the document, and thus, the system may automatically transmit an approval request to a user device associated with a team that has been identified to approve and resolve the rejection factor.

Additionally, and as shown in flow diagram 700, the processes described herein with respect to user device communications may be carried out on a SPEER network (or a secure peer network, which may be configured with a VPN, to allow for a secure network on a single browser for real time or near real time updating of the validation of the document.

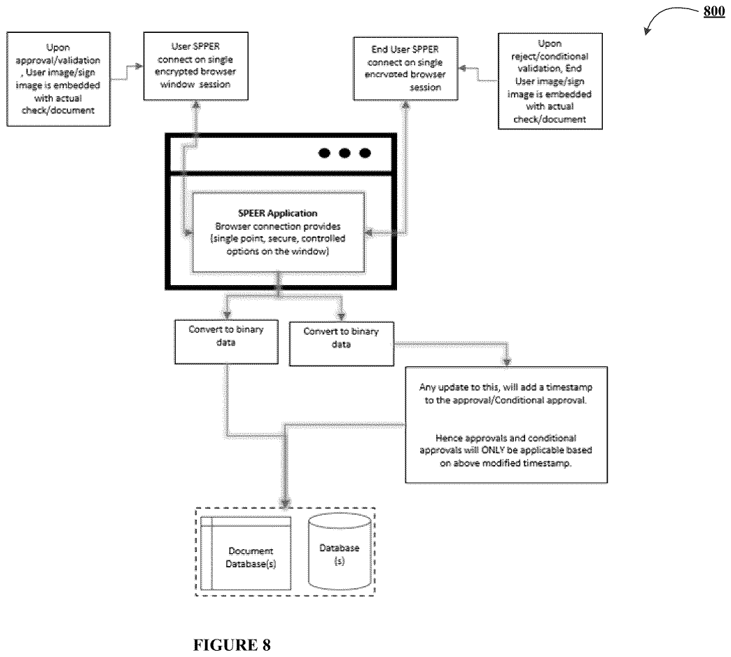

FIG. 8 illustrates a flow diagram 800 for using a SPEER network, generating an image of the user associated with each user device, and converting the image to a binary string, in accordance with an embodiment of the disclosure. In some embodiments, a system (e.g., similar to one or more of the systems described herein with respect to FIGS. 1A-1C) may perform one or more of the steps of flow diagram 800. For example, a system (e.g., the system 130 described herein with respect to FIG. 1A-1C) may perform the steps of flow diagram 800.

As shown in flow diagram 800, and upon approving the document and/or the rejection factor at the user device associated with a team identifier, the system may capture an image of the user or the user input and embed the image with the document or check. Additionally, the system may use the SPEER network for each of the user devices connecting to the network, and such a SPEER network may allow the user device(s) to connect on a single encrypted browser window session. Further, such a SPEER network may allow for the browser connection which further improves security by having a single point and controlled connection for the user devices.

Additionally, and as shown in flow diagram 800, the image of the user and/or the user input may be converted to a binary string, which may later be combined with the timestamp of the approval, conditional approval, user input, and/or the like. Upon generating the binary string with the timestamps, the binary string and timestamps may be stored in the user account database and/or the document database (e.g., the secret database).

Additionally, and in some embodiments, the SPEER network connection may be ended once a rejection of the document or rejection factor has been received. In contrast, and in some embodiments, the SPEER network connection may additionally be ended once the approval or user input has been received from the user device and no more user input is requested from that particular user device.

Importantly, this secure peer network (SPEER network) is unlike traditional networks as the SPEER network can be applied on a single browser window session and does not require its own personal computer or operating system. Moreover, such a SPEER network may not require any setup, as the setting up of the SPEER network will be on the management-entity side which further allows for controlled options, security, and only allowing for expected data. Thus, the SPEER network can act as a filter for expected data when it receives user inputs and data from the document and/or user account data. Additionally, and by using the SPEER network, the system may act as a filter at the management-entity, and allows for the management-entity to modify the filter as needed, while prevent modification by any threat actors or misappropriators. Therefore, the SPEER network may enable the capturing of external approvals, remote to the entity, and creating an image approval and conditional approval/validation mechanism using secret document databases. Additionally, the SPEER network may reduce the user account database and the document database's image field size, by converting and storing the image as a binary string instead of an image file. Further, and by allowing for the timestamp to be combined with the binary string, the system provides a logic to embed the timestamp to already existing data, and allows for the validity to be based on the original timestamp or any modified timestamps that may follow—and thus additional entries in the database or in any distributed ledgers can be avoided.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for validating data from disparate source inputs in a distributed validation network, the system comprising:
a memory device with computer-readable program code stored thereon;
at least one processing device operatively coupled to the memory device and at least one communication device, wherein executing the computer-readable code is configured to cause the at least one processing device to:
identify at least one document, wherein the at least one document comprises at least one alphanumeric character;
determine a user account identifier based on the at least one document or the at least one alphanumeric character;
extract user account data from a user account database based on the user account identifier;
apply the user account data to an alphanumeric generation engine;
generate, by the alphanumeric generation engine, an alphanumeric prompt; and
compare the alphanumeric prompt to the at least one alphanumeric character.

2. The system of claim 1, wherein executing the computer-readable code is configured to cause the at least one processing device to:
identify a document-generator user approval associated with the at least one document;
identify, based on the comparison of the alphanumeric prompt and the at least one alphanumeric character, a management entity approval or management entity disapproval; and
identify at least one of an end-user approval or an end-user disapproval.

3. The system of claim 2, wherein at least one of the management entity disapproval or the end-user disapproval is identified, and wherein executing the computer-readable code is configured to cause the at least one processing device to:
identify at least one rejection factor associated with the at least one document;
determine at least one team identifier associated with the at least one rejection factor;
transmit at least one approval request associated with the at least one rejection factor to at least one user device associated with the at least one team identifier; and
receive at least one approval from the at least one user device.

4. The system of claim 3, wherein the at least one user device comprises a plurality of user devices associated with a secure peer network applied on a browser window.

5. The system of claim 3, wherein the at least one user device comprises a plurality of user devices, and wherein the transmission of the at least one approval request comprises a plurality of approval requests transmitted in parallel.

6. The system of claim 3, wherein executing the computer-readable code is configured to cause the at least one processing device to:
capture an image of a user or a user account associated with the user device that transmitted the at least one approval;
embed the image into the at least one document in at least one document database; and
convert the image into a string of numeric characters.

7. The system of claim 5, wherein the at least one document database is a secret database.

8. The system of claim 1, wherein the at least one alphanumeric character comprises a string of numeric characters.

9. The system of claim 1, wherein the alphanumeric generation engine is a self-attentive transformer comprising at least one deep learning model.

10. A computer program product for validating data from disparate source inputs in a distributed validation network, wherein the computer program product comprises at least one non-transitory computer-readable medium having computer-readable program code portions embodied therein, the computer-readable program code portions which when executed by a processing device are configured to cause the processor to:
identify at least one document, wherein the at least one document comprises at least one alphanumeric character;
determine a user account identifier based on the at least one document or the at least one alphanumeric character;
extract user account data from a user account database based on the user account identifier;
apply the user account data to an alphanumeric generation engine;
generate, by the alphanumeric generation engine, an alphanumeric prompt; and
compare the alphanumeric prompt to the at least one alphanumeric character.

11. The computer program product of claim 10, wherein the computer-readable program code portions which when executed by the processing device are configured to cause the processor to:
identify a document-generator user approval associated with the at least one document;
identify, based on the comparison of the alphanumeric prompt and the at least one alphanumeric character, a management entity approval or management entity disapproval; and
identify at least one of an end-user approval or an end-user disapproval.

12. The computer program product of claim 11, wherein at least one of the management entity disapproval or the end-user disapproval is identified, and wherein the computer-readable program code portions which when executed by the processing device are configured to cause the processor to:
identify at least one rejection factor associated with the at least one document;
determine at least one team identifier associated with the at least one rejection factor;
transmit at least one approval request associated with the at least one rejection factor to at least one user device associated with the at least one team identifier; and
receive at least one approval from the at least one user device.

13. The computer program product of claim 12, wherein the at least one user device comprises a plurality of user devices associated with a secure peer network applied on a browser window.

14. The computer program product of claim 12, wherein the at least one user device comprises a plurality of user devices, and wherein the transmission of the at least one approval request comprises a plurality of approval requests transmitted in parallel.

15. The computer program product of claim 12, wherein the computer-readable program code portions which when executed by the processing device are configured to cause the processor to:
capture an image of a user or a user account associated with the user device that transmitted the at least one approval;
embed the image into the at least one document in at least one document database; and
convert the image into a string of numeric characters.

16. A computer implemented method for validating data from disparate source inputs in a distributed validation network, the computer implemented method comprising:
identifying at least one document, wherein the at least one document comprises at least one alphanumeric character;
determining a user account identifier based on the at least one document or the at least one alphanumeric character;
extracting user account data from a user account database based on the user account identifier;
applying the user account data to an alphanumeric generation engine;
generating, by the alphanumeric generation engine, an alphanumeric prompt; and
comparing the alphanumeric prompt to the at least one alphanumeric character.

17. The computer implemented method of claim 16, further comprising:
identifying a document-generator user approval associated with the at least one document;
identifying, based on the comparison of the alphanumeric prompt and the at least one alphanumeric character, a management entity approval or management entity disapproval; and
identifying at least one of an end-user approval or an end-user disapproval.

18. The computer implemented method of claim 17, wherein at least one of the management entity disapproval or the end-user disapproval is identified, further comprising:
identifying at least one rejection factor associated with the at least one document;
determining at least one team identifier associated with the at least one rejection factor;
transmitting at least one approval request associated with the at least one rejection factor to at least one user device associated with the at least one team identifier; and
receiving at least one approval from the at least one user device.

19. The computer implemented method of claim 18, wherein the at least one user device comprises a plurality of user devices, and wherein the transmission of the at least one approval request comprises a plurality of approval requests transmitted in parallel.

20. The computer implemented method of claim 18, further comprising:
capturing an image of a user or a user account associated with the user device that transmitted the at least one approval;
embedding the image into the at least one document in at least one document database; and
converting the image into a string of numeric characters.
